(19) United States
(12) Patent Application Publication
(10) Pub. No.: US 2019/0285221 A1
(43) Pub. Date: Sep. 19, 2019

(54) HOSE REINFORCING ASSEMBLY

(71) Applicant: Ruby Carter, Los Angeles, CA (US)

(72) Inventor: Ruby Carter, Los Angeles, CA (US)

(21) Appl. No.: 15/923,168

(22) Filed: Mar. 16, 2018

(51) Int. Cl. F16L 57/02

(52) U.S. Cl. CPC F16L 57/02

(57) ABSTRACT

A hose reinforcing assembly for inhibiting an existing kink in a hose from recurring includes a hose and a sleeve that is wrapped around the hose. The sleeve is positioned on an existing kink in the hose. Moreover, the sleeve is comprised of a resilient material to inhibit the existing kink from recurring. In this way the hose may deliver an uninterrupted supply of fluid. A hinge is coupled to the sleeve for opening and closing the sleeve.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to reinforcing devices and more particularly pertains to a new reinforcing device for inhibiting an existing kink in a hose from recurring.

### BRIEF SUMMARY OF THE INVENTION

An embodiment of the disclosure meets the needs presented above by generally comprising a hose and a sleeve that is wrapped around the hose. The sleeve is positioned on an existing kink in the hose. Moreover, the sleeve is comprised of a resilient material to inhibit the existing kink from recurring. In this way the hose may deliver an uninterrupted supply of fluid. A hinge is coupled to the sleeve for opening and closing the sleeve.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a sleeve of a hose reinforcing assembly according to an embodiment of the disclosure.

FIG. 2 is a right side view of an embodiment of the disclosure.

FIG. 3 is a cross sectional view taken along line 3-3 of FIG. 2 of an embodiment of the disclosure.

FIG. 4 is a left side view of an embodiment of the disclosure.

FIG. 5 is a perspective in-use view of an embodiment of the disclosure.

FIG. 6 is a phantom in-use view of an embodiment of the disclosure.

### DETAILED DESCRIPTION OF THE INVENTION

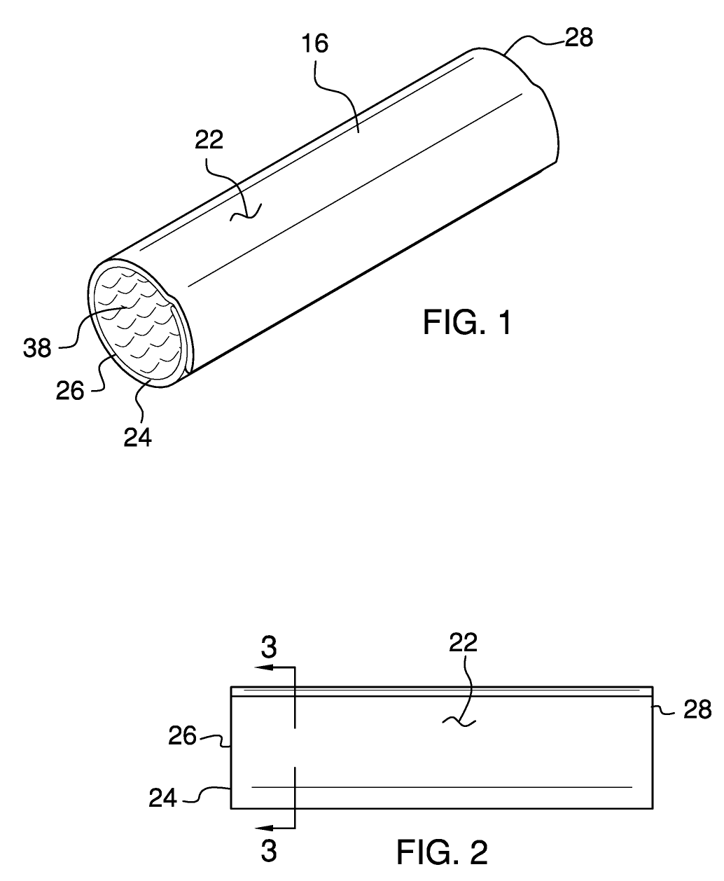

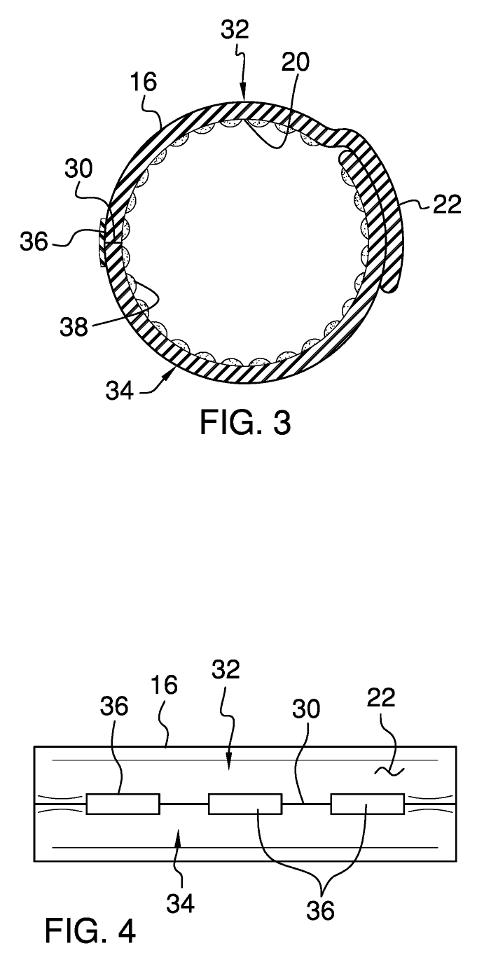

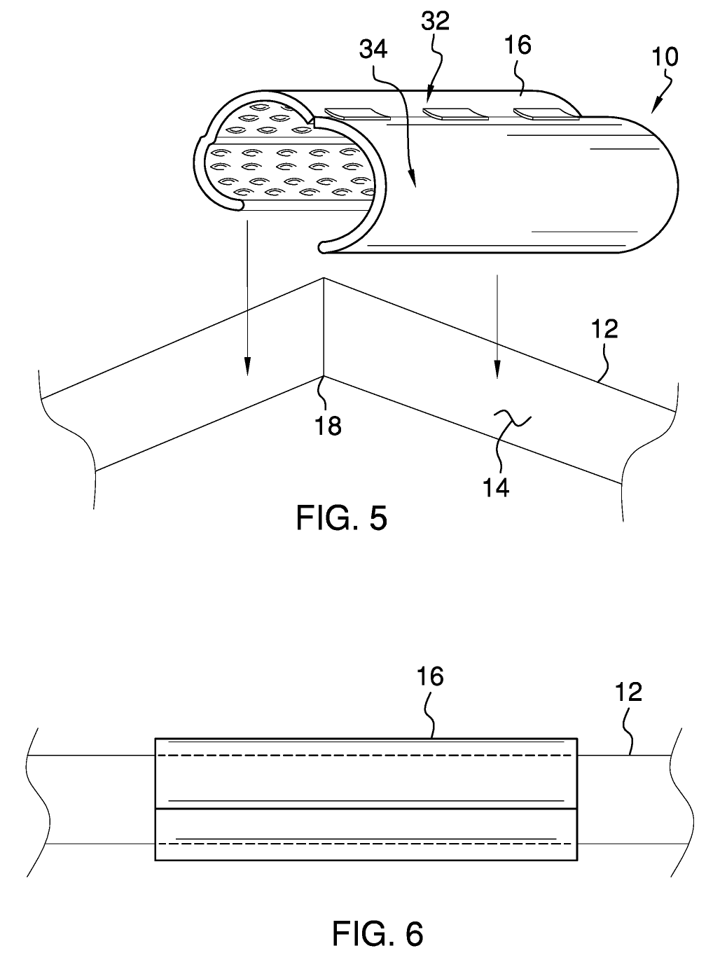

With reference now to the drawings, and in particular to FIGS. 1 through 6 thereof, a new reinforcing device embodying the principles and concepts of an embodiment of the disclosure and generally designated by the reference numeral 10 will be described.

As best illustrated in FIGS. 1 through 6, the hose reinforcing assembly 10 generally comprises a hose 12 that has an outer surface 14. The hose 12 may be a garden hose or the like and the hose 12 may be fluidly coupled to a fluid supply, such as hose bib or the like. A sleeve 16 is for wrapping around the hose 12 and the sleeve 16 is positioned on an existing kink 18 in the hose 12. The sleeve 16 is comprised of a resilient material, such as vulcanized rubber or the like, to inhibit the existing kink 18 from recurring. In this way the hose 12 is facilitated to deliver an uninterrupted supply of fluid.

The sleeve 16 has a first surface 20, a second surface 22 and a peripheral edge 24 extending therebetween, and the peripheral edge 24 has a first lateral side 26 and a second lateral side 28. The sleeve 16 has a cut 30 extending through the first surface 20 and the second surface 22 to define a first portion 32 of the sleeve 16 and a second portion 34 of the sleeve 16. The cut 30 extends between the first lateral side 26 and the second lateral side 28. Moreover, the first surface 20 of the first portion 32 of the sleeve 16 is matable to the second surface 22 of the second portion 34 of the sleeve 16 such that the sleeve 16 forms a closed loop around the hose 12. The sleeve 16 may include a pair of complementary hook and loop fasteners that are each positioned on respective one of the first surface 20 and the second surface 22 for closing the sleeve 16. Additionally, the first surface 20 of the first portion 32 of the sleeve 16 may resiliently adhere to the second surface 22 of the second portion 34 of the sleeve 16.

A hinge 36 is coupled to the sleeve 16 for opening and closing the sleeve 16 and the hinge 36 is positioned on the second surface 22 of the sleeve 16. The hinge 36 is aligned with the cut 30 such that the first portion 32 of the sleeve 16 is hingedly coupled to the second portion 34 of the sleeve 16. An adhesion layer 38 is coupled to the first surface 20 of the sleeve 16 and the adhesion layer 38 completely covers the first surface 20. The adhesion layer 38 frictionally engages the outer surface 14 of the hose 12 when the sleeve 16 is wrapped around the hose 12 to inhibit the sleeve 16 from sliding on the hose 12.

In use, the sleeve 16 is opened, the sleeve 16 is positioned on the hose 12 and the sleeve 16 is aligned with an existing kink 18 in the hose 12. The sleeve 16 is wrapped around the hose 12 and the first surface 20 of the first portion of the sleeve 16 is mated to the second surface 22 of the second portion 34 of the sleeve 16. In this way the sleeve 16 is retained around the hose 12. The adhesion layer 38 inhibits the sleeve 16 from sliding on the hose 12 thereby retaining the sleeve 16 on the existing kink 18. In this way the sleeve 16 inhibits the existing kink 18 in the hose 12 from reforming and potentially inhibiting fluid from flowing through the hose 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hose reinforcing assembly for inhibiting recurring kinks in a hose, said assembly comprising:
a hose;
a sleeve being wrapped around said hose, said sleeve being positioned on an existing kink in said hose, said sleeve being comprised of a resilient material to inhibit said existing kink from recurring wherein said hose is configured to deliver an uninterrupted supply of fluid; and
a hinge being coupled to said sleeve for opening and closing said sleeve.

2. The assembly according to claim 1, wherein said sleeve has a first surface, a second surface and a peripheral edge extending therebetween, said peripheral edge having a first lateral side and a second lateral side, said sleeve having a cut extending through said first surface and said second surface to define a first portion of said sleeve and a second portion of said sleeve, said cut extending between said first lateral side and said second lateral side.

3. The assembly according to claim 2, wherein said first surface of said first portion of said sleeve is matable to said second surface of said second portion of said sleeve such that said sleeve forms a closed loop around said hose.

4. The assembly according to claim 3, wherein said hinge is positioned on said second surface of said sleeve, said hinge being aligned with said cut such that said first portion of said sleeve is hingedly coupled to said second portion of said sleeve.

5. The assembly according to claim 2, further comprising an adhesion layer being coupled to said first surface of said sleeve, said adhesion layer completely covering said first surface, said adhesion layer frictionally engaging said outer surface of said hose when said sleeve is wrapped around said hose to inhibit said sleeve from sliding on said hose.

6. A hose reinforcing assembly for inhibiting recurring kinks in a hose, said assembly comprising:
a hose having an outer surface;
a sleeve being wrapped around said hose, said sleeve being positioned on an existing kink in said hose, said sleeve being comprised of a resilient material to inhibit said existing kink from recurring wherein said hose is configured to deliver an uninterrupted supply of fluid, said sleeve having a first surface, a second surface and a peripheral edge extending therebetween, said peripheral edge having a first lateral side and a second lateral side, said sleeve having a cut extending through said first surface and said second surface to define a first portion of said sleeve and a second portion of said sleeve, said cut extending between said first lateral side and said second lateral side, said first surface of said first portion of said sleeve being matable to said second surface of said second portion of said sleeve such that said sleeve forms a closed loop around said hose;
a hinge being coupled to said sleeve for opening and closing said sleeve, said hinge being positioned on said second surface of said sleeve, said hinge being aligned with said cut such that said first portion of said sleeve is hingedly coupled to said second portion of said sleeve; and
an adhesion layer being coupled to said first surface of said sleeve, said adhesion layer completely covering said first surface, said adhesion layer frictionally engaging said outer surface of said hose when said sleeve is wrapped around said hose to inhibit said sleeve from sliding on said hose.
